(19) United States
(12) Patent Application Publication
(10) Pub. No.: US 2014/0143553 A1
(43) Pub. Date: May 22, 2014

(54) Method and Apparatus for Encapsulating and Encrypting Files in Computer Device

(71) Applicant: CLOUDIOH INC., Taipei City (TW)

(72) Inventor: Yan-Cheng Chang, New Taipei City (TW)

(73) Assignee: CLOUDIOH INC., Taipei City (TW)

(21) Appl. No.: 13/855,697

(22) Filed: Apr. 2, 2013

Related U.S. Application Data
(60) Provisional application No. 61/728,237, filed on Nov. 20, 2012.

(51) Int. Cl. H04L 9/28; G06F 12/14

(52) U.S. Cl. CPC H04L 9/28; G06F 12/1408
USPC 713/190

(57) ABSTRACT

A method for maintaining a single file in a shared storage is disclosed. The method comprises storing the single file and corresponding information into a virtual disk so that there is a direct mapping between each file byte and a byte in a sector of the virtual disk; encrypting the virtual disk according to a disk encryption algorithm; and uploading the encrypted virtual disk to the shared storage.

### CROSS REFERENCE TO RELATED APPLICATIONS

This application claims the benefit of U.S. Provisional Application No. 61/728,237, filed on Nov. 20, 2012, entitled “Secure and Efficient Systems for Operations against Encrypted Files”, the contents of which are incorporated herein in their entirety.

### BACKGROUND OF THE INVENTION

1. Field of the Invention

The present invention relates to a method and apparatus utilized in a computer device, and more particularly, to a method and apparatus for encapsulating and encrypting files in a computer device.

2. Description of the Prior Art

Nowadays, users often collaborate on computer files in a shared storage provided by an internal corporate information technology department or an external service provider, such as Box, Dropbox or Google Drive. For example, if a file is stored in Google Drive, a collaborator who works on a local copy of the file in a personal computer using certain computer software can update the remote version in Google Drive with his local revision. And other collaborators can further access the new version of the file.

For privacy and confidentiality reasons, encrypting the file is desirable before uploading the file to the shared storage. In practice, computer files are usually encrypted by using a block cipher with a confidentiality mode of operation. In brief, a computer file is split into blocks and one of the blocks is coded by using the block cipher following the confidentiality mode of operation. The block cipher can be Advanced Encryption Standard (AES) algorithm, Triple Data Encryption Algorithm (DEA) or Skipjack and the confidentiality mode of operation can be Electronic codebook (ECB), Cipher-block chaining (CBC), Cipher feedback (CFB), Output feedback (OFB) or Counter (CTR). However, these block ciphers and confidentiality modes of operation may lead to be inefficient or complex. For example, in CBC and CFB modes, a change made to the first byte of a file results in the need of re-encryption for the whole file. In OFB mode, a change made to the last byte of a file results in the need of executing block cipher algorithm as many times as if the whole file is re-encrypted. In other words, for CBC, CFB and OFB modes, a small update on a file may result in work close to re-encrypting the whole file. Therefore, the computation and communication is inefficient and undesirable for a large file. In another aspect, for CTR mode, a random initialization vector is required for all blocks split from a file and recorded after all blocks of the file are encrypted. The random initialization vector should be a new one for keeping secure when a file is updated to a new version, which leads to complex maintenance.

Therefore, a method for efficiently maintaining a file in encrypted form is necessary.

### SUMMARY OF THE INVENTION

The present invention therefore provides a method and apparatus for maintaining a file in encrypted form in a computer device by efficiently encapsulating and encrypting the file.

A method for maintaining a single file in a shared storage is disclosed. The method comprises storing the single file and corresponding information into a virtual disk so that there is a direct mapping between each file byte and a byte in a sector of the virtual disk; encrypting the virtual disk according to a disk encryption algorithm; and uploading the encrypted virtual disk to the shared storage.

A computer readable medium comprising multiple instructions stored in a computer readable device is disclosed. Upon executing these instructions, a computer performs storing a single file and corresponding information into a virtual disk so that there is a direct mapping between each file byte and a byte in a sector of the virtual disk; encrypting the virtual disk according to a disk encryption algorithm; and uploading the encrypted virtual disk to the shared storage.

An electronic device, comprises a processing means; a storage unit; and a program code, stored in the storage unit, wherein the program code instructs the processing means to execute the following steps: storing a file and corresponding information into a virtual disk so that there is a direct mapping between each file byte and a byte in a sector of the virtual disk; encrypting the virtual disk according to a disk encryption algorithm; and uploading the encrypted virtual disk to a shared storage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a network system according to an example of the present invention.

FIG. 2 is a schematic diagram of a computer apparatus according to an example of the present invention.

FIG. 3 is a flowchart of a process according to examples of the present invention.

FIG. 4 is a flowchart of a process according to examples of the present invention.

FIG. 5 is a flowchart of a process according to examples of the present invention.

FIG. 6 is a flowchart of a process according to examples of the present invention.

### DETAILED DESCRIPTION

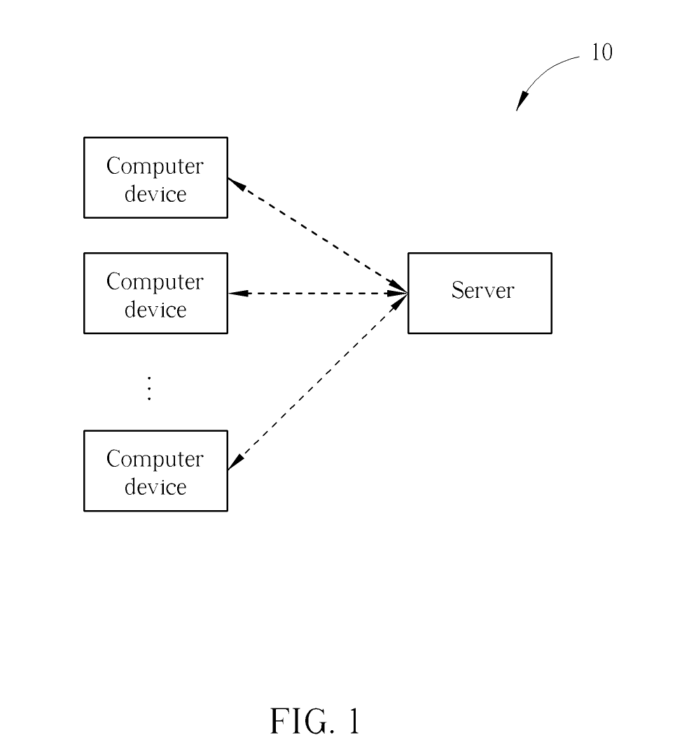

Please refer to FIG. 1, which is a schematic diagram of a network system 10 according to an example of the present invention. The network system 10 is briefly composed of a server and a plurality of computer devices. In FIG. 1, the server and the computer devices are simply utilized for illustrating the structure of the network system 10. Practically, the server can be an internal corporate information technology or an external service provider, such as Box, Dropbox or Google Drive, providing a shared storage. Besides, users may manage the shared storage by remote access in the computer devices.

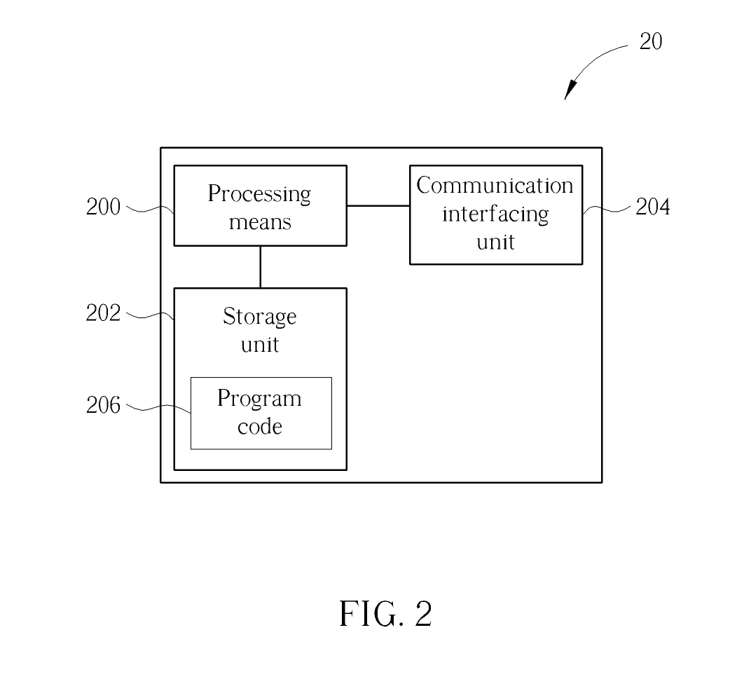

Please refer to FIG. 2, which is a schematic diagram of a computer apparatus 20 according to an example of the present invention. The computer apparatus 20 can be one of the computer devices shown in FIG. 1, but is not limited thereto. The computer apparatus 20 may include a processing means 200 such as a microprocessor or Application Specific Integrated Circuit (ASIC), a storage unit 202 and a communication interfacing unit 204. The storage unit 202 may be any data storage device that can store a program code 206, accessed and executed by the processing means 200. Examples of the storage unit 202 include but are not limited to read-only memory (ROM), flash memory, random-access memory (RAM), CD-ROM/DVD-ROM, magnetic tape, hard disk and optical data storage device. The communication interfacing unit 204 is preferably a transceiver and is used to transmit and receive signals (e.g., messages or packets) according to processing results of the processing means 200.

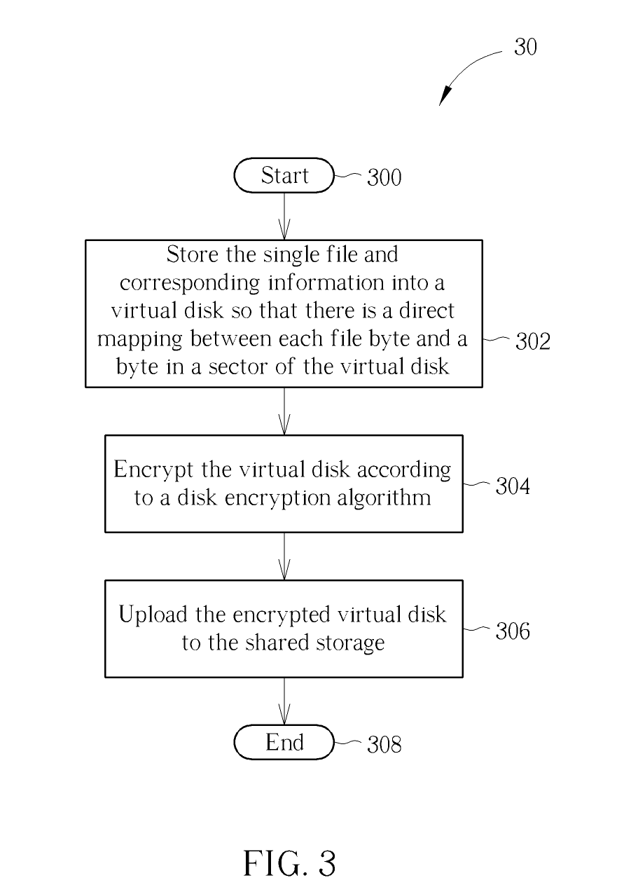

Please refer to FIG. 3, which is a flowchart of a process 30 according to an example of the present invention. The process 30 is utilized in the network system 10 shown in FIG. 1, for maintaining a single file stored in the shared storage by one of the computer devices, to efficiently encrypt the single file. The process 30 can be implemented in the computer apparatus 20 and may be compiled into the program code 206. The process 30 includes the following steps:

Step 300: Start.

Step 302: Store the single file and corresponding information into a virtual disk so that there is a direct mapping between each file byte and a byte in a sector of the virtual disk.

Step 304: Encrypt the virtual disk according to a disk encryption algorithm.

Step 306: Upload the encrypted virtual disk to the shared storage.

Step 308: End.

According to the process 30, the user stores the single file and the corresponding information into the virtual disk and encrypts the virtual disk according to the disk encryption algorithm. Since the disk encryption algorithm fast encrypts the virtual disk and the virtual disk stores the single file only, the user can efficiently encrypt the single file via the disk encryption algorithm to share the single file with other collaborators.

In detail, the disk encryption algorithm possesses three properties. The properties are shown in the following:
(1) The data on the disk should remain confidential.
(2) Data retrieval and storage should both be fast operations, no matter where on the disk the data stored.
(3) The encryption method should not waste disk space.

Therefore, the process 30 requires no initialization vector (IV) for encryption, as otherwise the storage overhead is unacceptable. Moreover, the process 30 also provides the possibility of fast random accesses and updates and further content security.

However, the user may need to append or delete a content to/from the single file after encrypting the single file. In detail, for appendance, the user may append a content to the single file which is obtained from the encrypted virtual disk by decrypting sectors of the encrypted virtual disk, so that the virtual disk should be expended and re-encrypted for the updated part of the virtual disk as a new version. For deletion, the user may delete a content from the single file which is obtained from the encrypted virtual disk by decrypting sectors of the encrypted virtual disk, so that the virtual disk is shrunk and re-encrypted for the updated part of the virtual disk as a new version.

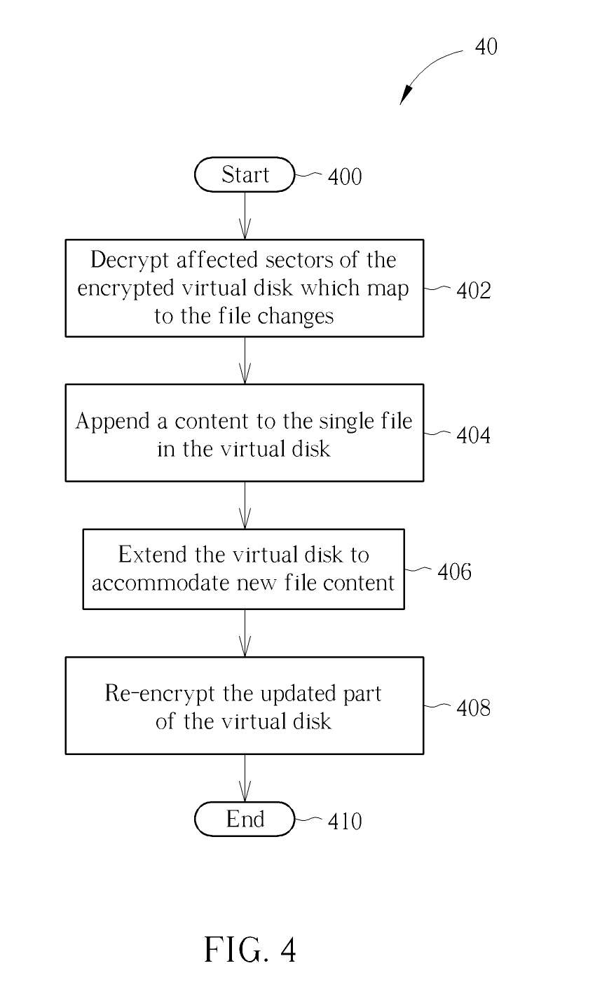

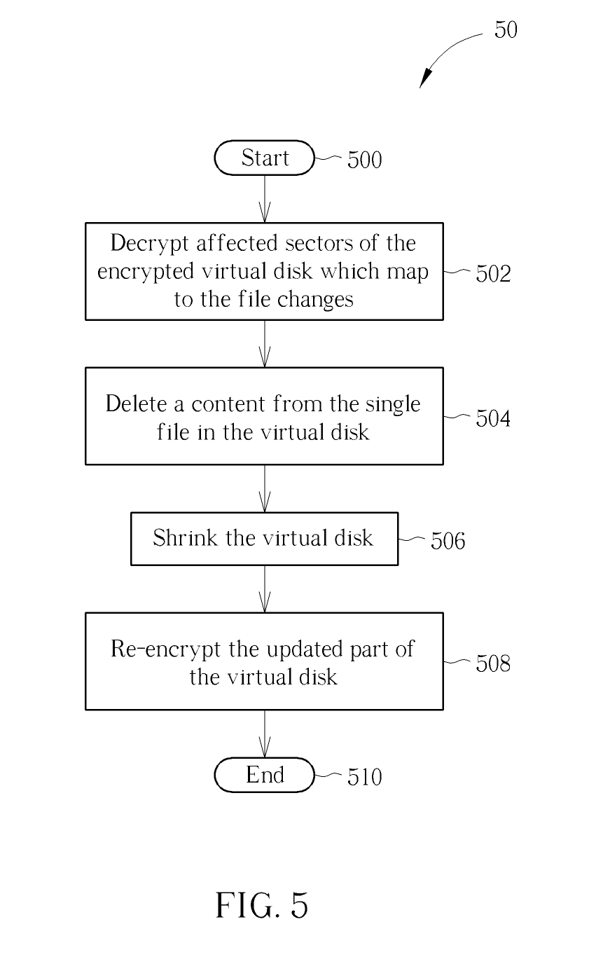

As seen from the above, the appending and deleting operations can be summarized to processes 40 and 50, as shown in FIGS. 4-5. The processes 40 and 50 can be implemented in the computer apparatus 20 and may be respectively or jointly compiled into the program code 206. The process 50 includes the following steps:

Step 400: Start.

Step 402: Decrypt affected sectors of the encrypted virtual disk which map to the file changes.

Step 404: Append a content to the single file in the virtual disk.

Step 406: Extend the virtual disk to accommodate new file content.

Step 408: Re-encrypt the updated part of the virtual disk.

Step 410: End.

The process 50 includes the following steps:

Step 500: Start.

Step 502: Decrypt affected sectors of the encrypted virtual disk which map to the file changes.

Step 504: Delete a content from the single file in the virtual disk.

Step 506: Shrink the virtual disk.

Step 508: Re-encrypt the updated part of the virtual disk.

Step 510: End.

Note that, the processes 30, 40 and 50 are examples of the present invention, and those skilled in the art should readily make combinations, modifications and/or alterations on the abovementioned description and examples. For example, the encrypting and decrypting functions may be a XTS-AES algorithm. Besides, a size of the virtual disk is dynamically configured. In addition, the appending and deleting operations for the single file can also be executed by other collaborators.

In another aspect, in the process 40, Step 402 can be omitted when the content appended to the file belongs to a newly-extended sector of the virtual disk. In other words, the content appended to the file does not affect the original contents of the file, so that the original sectors of the virtual disk corresponding to the original contents of the file do not need to be re-encrypted. In addition, when the contents of the file in the affected sectors of the encrypted virtual disk are updated and the amount of the existing sectors is not changed, the user should only need to update and re-encrypt the affected sectors of the virtual disk but not append or shrink the virtual disk.

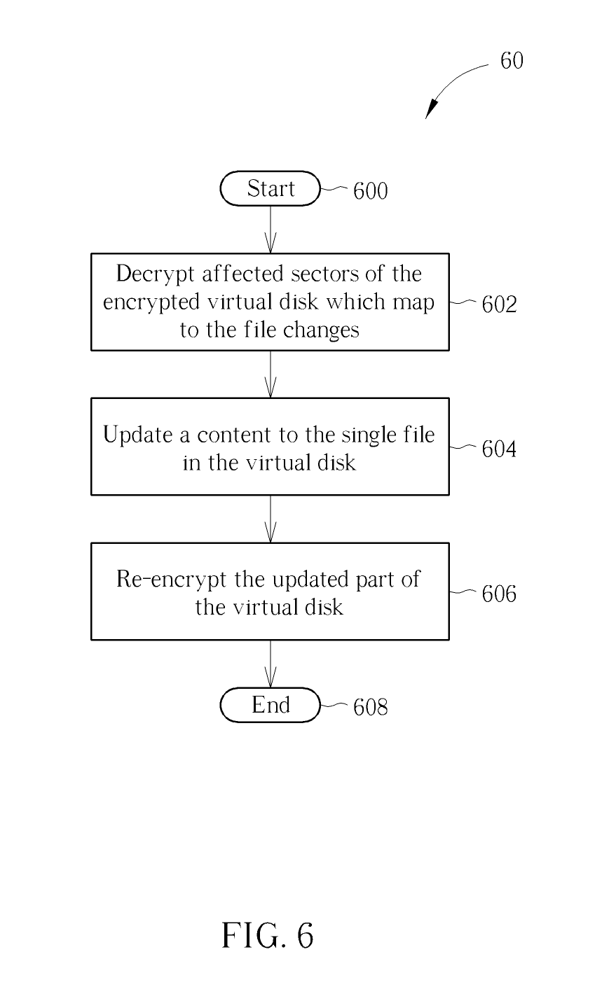

The updating operation without appending or shrinking the virtual disk can be summarized to a process 60, as shown in FIG. 6. The process 60 can be implemented in the computer apparatus 20 and may be respectively or jointly compiled into the program code 206. The process 60 includes the following steps:

Step 600: Start.

Step 602: Decrypt affected sectors of the encrypted virtual disk which map to the file changes.

Step 604: Update a content to the single file in the virtual disk.

Step 606: Re-encrypt the updated part of the virtual disk.

Step 608: End.

In the present invention, the computer device stores the single file and the information corresponding to the single file in the virtual disk and encrypts the virtual disk according to the disk encryption algorithm, so that a user can efficiently encrypt the single file and further share the single file with other collaborators. Moreover, the user can also use the virtual disk and the disk encryption algorithm to fast update, append and delete a part of the single file. Therefore, the user can fast encrypt the single file or a part of the single file according to the disk encryption algorithm and further efficiently maintain and share the single file with other collaborators.

To sum up, the present invention provides a method and apparatus for maintaining the single file by storing the single file in the virtual disk, to speed up the operations of encrypting the single file and keep the security of the single file in the shared storage.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for maintaining a single file in a shared storage, comprising:
storing the single file and corresponding information into a virtual disk so that there is a direct mapping between each file byte and a byte in a sector of the virtual disk;
encrypting the virtual disk according to a disk encryption algorithm; and
uploading the encrypted virtual disk to the shared storage.

2. The method of claim 1, wherein the method further comprises:
decrypting a sector of the encrypted virtual disk;
changing a content of the single file in the virtual disk; and
re-encrypting a part of the virtual disk corresponding to the content;
wherein changing the content of the single file comprises at updating, appending or deleting the content of the single file.

3. The method of claim 2, wherein the method further comprises shrinking or extending the virtual disk when an amount of the sectors of the encrypted virtual disk is changed.

4. The method of claim 1, wherein a size of the virtual disk is dynamically configured.

5. The method of claim 1, wherein the disk encryption algorithm is a XTS-AES algorithm.

6. A computer readable medium comprising multiple instructions stored in a computer readable device, upon executing the instructions, a computer performing the following steps:
storing a single file and corresponding information into a virtual disk so that there is a direct mapping between each file byte and a byte in a sector of the virtual disk;
encrypting the virtual disk according to a disk encryption algorithm; and
uploading the encrypted virtual disk to the shared storage.

7. The computer readable medium of claim 6, wherein upon executing the instructions, the computer further performs:
decrypting a sector of the encrypted virtual disk;
changing a content of the single file in the virtual disk; and
re-encrypting a part of the virtual disk corresponding to the content;
wherein changing the content of the single file comprises updating, appending or deleting the content of the single file.

8. The computer readable medium of claim 7, wherein upon executing the instructions, the computer further performs shrinking or extending the virtual disk, when an amount of the sectors of the encrypted virtual disk is changed.

9. The computer readable medium of claim 6, wherein a size of the virtual disk is dynamically configured.

10. The computer readable medium of claim 6, wherein the disk encryption algorithm is a XTS-AES algorithm.

11. An electronic device, comprising:
a processing means;
a storage unit; and
a program code, stored in the storage unit, wherein the program code instructs the processing means to execute the following steps:
storing a file and corresponding information into a virtual disk so that there is a direct mapping between each file byte and a byte in a sector of the virtual disk;
encrypting the virtual disk according to a disk encryption algorithm; and
uploading the encrypted virtual disk to a shared storage.

12. The electronic device of claim 11, wherein the program code further instructs the processing means to execute:
decrypting a sector of the encrypted virtual disk;
changing a content of the single file in the virtual disk; and
re-encrypting a part of the virtual disk corresponding to the content;
wherein changing the content of the single file comprises updating, appending or deleting the content of the single file.

13. The electronic device of claim 12, wherein the program code further instructs the processing means to execute shrinking or extending the virtual disk, when an amount of the sectors of the encrypted virtual disk is changed.

14. The electronic device of claim 11, wherein a size of the virtual disk is dynamically configured.

15. The electronic device of claim 11, wherein the disk encryption algorithm is a XTS-AES algorithm.
